(19) United States
(12) Patent Application Publication
(10) Pub. No.: US 2017/0076384 A1
(43) Pub. Date: Mar. 16, 2017

(54) SYSTEM FOR DETERMINATION AND TRACKING OF ASSET LINEAGE

(71) Applicant: BANK OF AMERICA CORPORATION, Charlotte, NC (US)

(72) Inventors: Katherine Dintenfass, Charlotte, NC (US); Matthew Hsieh, Charlotte, NC (US); William F. Borowski, Millbury, MA (US); Alicia C. Jones-McFadden, Fort Mill, SC (US); Scott R. Enscoe, JR., Charlotte, NC (US); Kevin Andrew O'Neil, JR., Hamilton, NJ (US); Minh N. Vuong, Clovis, CA (US)

(21) Appl. No.: 14/853,663

(22) Filed: Sep. 14, 2015

(51) Int. Cl. G06Q 40/06

(52) U.S. Cl. CPC G06Q 40/06

(57) ABSTRACT

Embodiments of the invention are directed to systems, methods, and computer program products for generating and updating a benefactor profile comprising designations made by a benefactor for at least one beneficiary to receive assets from one or more financial accounts managed by the benefactor. Embodiments of the invention may be configured to store an electronic asset profile for the one or more assets comprising beneficiary information; store one or more limitations received from a benefactor comprising rules for communicating to a beneficiary regarding details associated with the one or more assets; create a beneficiary profile for the user; receive from the user a request to retrieve the details associated with the one or more assets from the beneficiary profile; and allow the user to view the beneficiary profile, whereby the user only sees information regarding the one or more assets as instructed by the benefactor.

### BACKGROUND

Efficient disposition of assets at a triggering event is important to ensure efficient disposal of assets and efficient access and use of those assets by the recipient. While many systems are benefactor driven and allow the benefactor to view each asset, monitor it, and designate beneficiaries, systems have not been developed that provide a beneficiary with information regarding assets to which they are designated. Thus, systems are needed for efficient managements and disposition of assets.

### BRIEF SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the invention are directed to systems, methods, and computer program products for communicating beneficiary information to a user associated with one or more assets.

In some embodiments, the invention is configured to store an electronic asset profile for the one or more assets. The asset profile comprises beneficiary information designating one or more beneficiaries associated with the one or more assets and rules associated with allocation of the one or more assets to the one or more beneficiaries.

The invention may then be configured to store one or more limitations received from a benefactor associated with the one or more assets. The one or more limitations comprise rules for communicating to a beneficiary regarding details associated with the one or more assets.

Based on the asset profile, the invention may create a beneficiary profile for the user. The beneficiary profile includes details associated with the one or more assets that list the user as a beneficiary.

In some embodiments, the invention is configured to receive from the user a request to retrieve the details associated with the one or more assets from the beneficiary profile. The invention may then be configured to allow the user to view the beneficiary profile. Information provided to the user in the displayed beneficiary profile is limited by the one or more limitations for communicating details included in the beneficiary profile. Accordingly, the user only sees information regarding the one or more assets as instructed by the benefactor associated with the one or more assets.

In other embodiments, the invention is configured to receive electronic information from a testamentary document of a benefactor. Using the electronic information from the testamentary document, the invention may identify a testamentary designation made by the benefactor regarding an asset including one or more designations of beneficiaries. The invention may then update the asset profile for the one or more beneficiaries associated with the asset based on the testamentary designation.

In other embodiments of the invention, the invention may be configured to generate a benefactor profile for the benefactor. The benefactor profile includes a list of assets owned or controlled by the benefactor and designates beneficiary information for each asset. In The invention may receive one or more updates to the list of assets owned or controlled by the benefactor. The one or more updates comprise at least one of a change to an amount or type of an asset, and a change to a beneficiary associated with at least one asset of the list of assets. Further, the invention may update the beneficiary profile based on the one or more updates. Based on the updates, the invention may communicate a notification to the beneficiary associated with the at least one asset. The communication is limited by the one or more limitations for communicating details included in the beneficiary profile.

The beneficiary information may comprise at least a type of one or more financial accounts associated with the asset profile, information related to additional beneficiaries of the one or more financial accounts, an executor of the one or more financial accounts, and an identifier of the benefactor.

In other embodiments of the invention, the invention may determine an occurrence of a triggering event associated with an asset. The invention may further determine that at least one of the one or more limitations is expired based on the occurrence of the triggering event. Accordingly, the invention may identify one or more details associated with the one or more assets that were not previously communicated to the user due to the one or more limitations. Communicating the one or more details that were not previously communicated to the user may be based on determining the occurrence of the triggering event.

While in other embodiments of the invention, the invention may be configured to determine an occurrence of a triggering event associated with an asset. The triggering event indicates that the asset is available to be distributed. The invention may then identify an account of the user for receiving at least a portion of the one or more assets. Further, the invention may be configured to transfer the portion of the one or more assets into the identified account of the user.

### BRIEF DESCRIPTION OF THE DRAWINGS

Having thus described embodiments of the invention in general terms, reference will now be made to the accompanying drawings, where:

FIG. 1 is a diagram illustrating a beneficiary designation environment, in accordance with embodiments of the present invention;

FIG. 2 is a flow chart illustrating a general process flow for communicating beneficiary information, in accordance with various embodiments of the invention;

FIG. 3 is a flow chart illustrating a general process flow for creating and updating a benefactor profile, in accordance with various embodiments of the present invention; and

FIG. 4 is a flow chart illustrating a general process flow for generating and presenting a beneficiary profile to a beneficiary, in accordance with various embodiments of the present invention.

### DETAILED DESCRIPTION OF EMBODIMENTS OF THE INVENTION

Embodiments of the present invention may now be described more fully hereinafter with reference to the accompanying drawings, in which some, but not all, embodiments of the invention are shown. Indeed, the invention may be embodied in many different forms and should not be construed as limited to the embodiments set forth herein. Rather, these embodiments are provided so that this disclosure may satisfy applicable legal requirements. Like numbers refer to like elements throughout.

Embodiments of the invention are directed to systems, methods, and computer program products for communicating beneficiary information, which includes designations made by a benefactor for a beneficiary to receive property from one or more financial accounts managed by the benefactor. The invention generates a benefactor profile on behalf of a benefactor. The benefactor profile may be updated to include the beneficiary information, limitations for communicating details of designations made by the benefactor, account information for the one more accounts managed by the benefactor, and additional benefactor information for life or estate planning. The benefactor may update the benefactor profile as needed to include each of the items mentioned. When making a designation for a beneficiary to receive an asset from the one or more accounts managed by the benefactor, the benefactor may define the beneficiary, an amount and type of the asset to which the beneficiary may receive, and the account that holds the asset. The benefactor may further define limitations on sending communications related to details of the designation. The limitations may prevent communications be sent to a person or a group of people. Further, the limitations may prevent communications be sent at certain periods. With respect to preventing communications being sent to a person or group of people, the benefactor may define a given individual or group of individuals that are subject to limitation (e.g. the beneficiary). The benefactor may also define a person or group of people that may be exempt from the limitation (e.g. executors). With respect to preventing communication based on time, the benefactor may define a period of time when the limitation will be in effect. This may be a set date in the future or a calculable date. Alternatively, the benefactor may further define a triggering event that causes the limitation to expire. The triggering event may be a life event of the benefactor and may include, but is not limited to, a birth of a child, a wedding, purchasing a home, going to college, retirement, death, and the like. Further, the triggering event may further be defined by the death of the benefactor. Thus, a limitation may be placed in effect so long as the benefactor remains alive and upon the death of the benefactor, the limitation expires. The limitation may further include details of the designation made by the benefactor. The details may include, but are not limited to, an amount or type of property, an account with general structure and type, financial institution information, additional information about other beneficiaries, executor information, and the like. In particular, the details may further include an overview of what beneficiaries are assigned to different accounts of the benefactor. The benefactor may designate multiple limitations to direct when communications may be sent to different individuals.

The invention is further directed to a beneficiary being able to receive details of designations made by a benefactor for the beneficiary to receive assets from one or more financial accounts managed by the benefactor. Similar to the benefactor profile, a beneficiary profile may be set up on behalf of a beneficiary and may contain information related to the designations made by the benefactor that name the beneficiary. However, where the benefactor profile may include multiple designations that name different beneficiaries, the designations in the beneficiary profile are related to the beneficiary, even if the relation is to a group of individuals to which the beneficiary is included. For example, a designation may be made by a benefactor that specifies each of the grandchildren of the benefactor to receive equal portions of an asset owned or controlled by the benefactor. The designation would be included in the beneficiary profile, if the beneficiary were a grandchild of the benefactor. The designation would also be included in the benefactor profile of the benefactor. Additionally, if a second benefactor made a designation that named the beneficiary, the designation made by the second benefactor would appear in the beneficiary profile of the beneficiary. The designation would further be included in the benefactor profile of the second benefactor but not in the first. Therefore, the beneficiary profile may include designations made by multiple benefactors. The beneficiary profile is created and updated based on the benefactor profiles. Therefore, if a benefactor profile is updated, the beneficiary profile becomes updated. A beneficiary profile may be generated when a benefactor specifies the beneficiary in a designation. A search may be made to determine that a beneficiary profile has already been created, and if not, a new one is created. If a beneficiary profile has been created, details of the designation may be included in the beneficiary profile. Alternatively, the beneficiary profile may be created in an alternative manner. Instead of generating a beneficiary profile when a benefactor specifies the beneficiary, the beneficiary or a representative may submit identification information of the beneficiary. This information may be received and a search is performed based on the information to determine whether the beneficiary can be identified. If the beneficiary is not identified, a beneficiary profile may be generated and a search of benefactor profiles may be conducted to determine whether any benefactor has named the beneficiary in a designation. If designations are found that name the beneficiary, such designations are included in the beneficiary profile of the beneficiary.

However, even with a beneficiary profile, the beneficiary may be prevented from viewing details of a given designation included in the beneficiary profile. As stated above, a benefactor may include limits for communications details of a designation to certain individuals. Therefore, if the benefactor has included a limit that prevents communications to the beneficiary the beneficiary may not receive such details. However, if the limitation expires or if the beneficiary is allowed to receive communications of the details of the designation, such communications may be sent to the beneficiary.

In addition to determining when a limitation expires, a triggering event may be further used to determine when the asset may be distributed. In distributing an asset, an account of the beneficiary may be identified and the property may be transferred into such account. Alternatively, the beneficiary may be given access to manage the financial account.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loans associations, credit unions, investment companies, insurance companies and the like. In some embodiments, the entity may allow a user to establish an account with the entity.

As used herein, an “account” or “financial account” may be the relationship that the user has with the entity. Examples of accounts include a deposit account, such as a transaction account (e.g. banking account), a savings account, an investment account, a money market account, a time deposit, a demand deposit, a pre-paid account, a credit account, a rewards account, an electronic wallet, a non-monetary user profile that includes only personal information with the user, or the like. The account is associated with and/or maintained by the entity. In other embodiments, an entity may not be a financial institution. In still other embodiments, the entity may be a merchant.

In some embodiments, a “user” may be a customer (e.g. an account holder or a person who has an account at the entity) or a potential customer (e.g. person who has submitted an application for an account, a person who is the target of marketing materials that are distributed by the entity, a person who applies for a loan that has not yet been funded). Additionally, the user may be a “benefactor” that manages multiple financial accounts that each includes property. The benefactor is capable of creating designations for a user to receive at least a portion of the property from one of the accounts.

The term “designation,” as used herein, may be a testamentary gift, bequest, or disposition of property by a benefactor that is testamentary in nature. A “beneficiary” is a person that is a recipient or a potential recipient of property from a designation made by a benefactor.

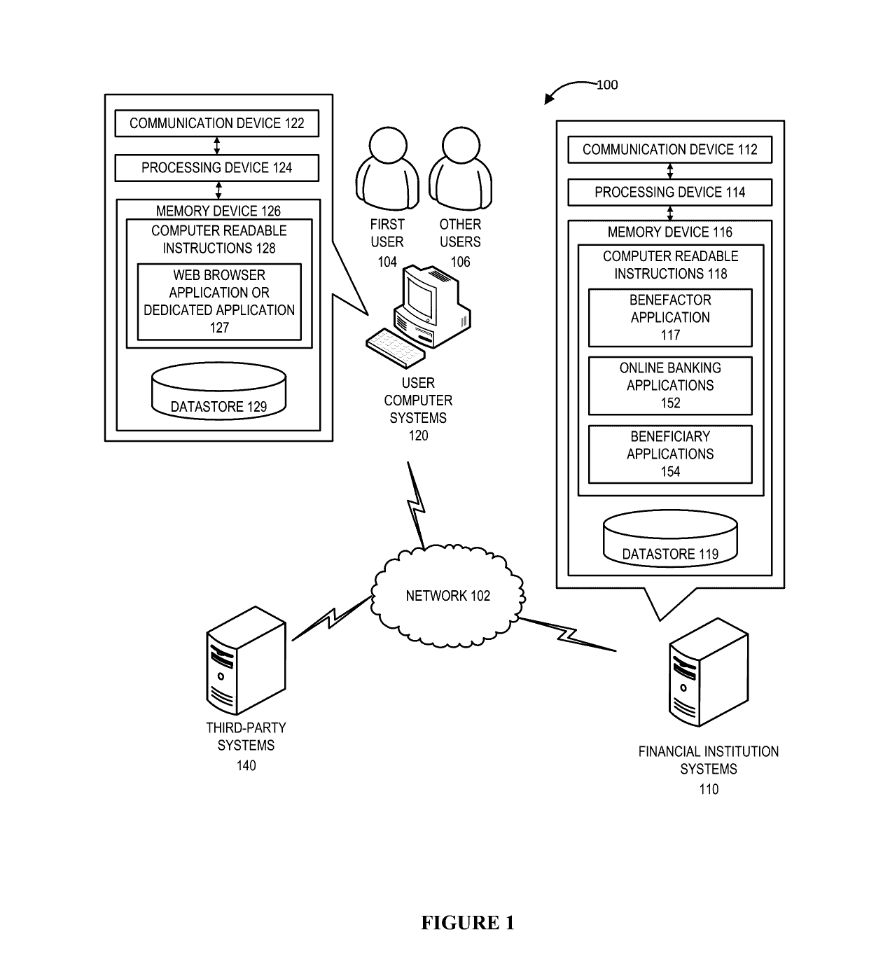

FIG. 1 illustrates a beneficiary designation environment 100, in accordance with an embodiment of the present invention. As illustrated in FIG. 1, one or more financial institution systems 110 are operatively coupled, via a network 102, to one or more user computer systems 120 (e.g., first user computer systems, second user computer systems, or other user computer systems), and/or one or more third-party systems 140. In this way, the first user 104 (e.g., benefactor, or the like) and the other users 106 (e.g., the second user 106, beneficiary, or the like which may or may not be customers of the financial institution) may utilize the one or more user computer systems 120 to access the financial institution applications, such as the benefactor applications 117, the online banking application 152, the beneficiary applications 154, or other like applications of the financial institution for a benefactor, to create a designation for a beneficiary to receive property from one or more financial accounts managed by the benefactor, and a beneficiary to receive details of such designation made by the benefactor.

In some embodiments of the invention, the one or more financial institution systems 110 may store user profile information, account information, financial information, transaction history, or the like about the users 104, 106, that are customers of the financial institution or associated with customers of the financial institutions. This information may include financial information of the benefactor, designations made by the benefactor for a beneficiary to receive an asset from one or more financial accounts managed by the benefactor, information of the beneficiary, estate planning information and the like.

The network 102 may be a global area network (GAN), such as the Internet, a wide area network (WAN), a local area network (LAN), or any other type of network or combination of networks. The network 102 may provide for wireline, wireless, or a combination of wireline and wireless communication between systems, services, and/or devices on the network 102.

As illustrated in FIG. 1, the financial institution systems 110 generally comprise one or more communication devices 112, one or more processing devices 114, and one or more memory devices 116. The one or more processing devices 114 are operatively coupled to the one or more communication devices 112 and the one or more memory devices 116. As used herein, the term “processing device” generally includes circuitry used for implementing the communication and/or logic functions of a particular system. For example, a processing device 114 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The one or more processing devices 114 may include functionality to operate one or more software programs based on computer-readable instructions 118 thereof, which may be stored in the one or more memory devices 116.

The one or more processing devices 114 use the one or more communication devices 112 to communicate with the network 102 and other devices on the network 102, such as, but not limited to, the user computer systems 120, third-party systems 140, or other like systems. As such, the one or more communication devices 112 generally comprises a wireless transceiver, modem, server, electrical connection, or other device for communicating with other devices on the network 102. The one or more communication devices 112 may further include an interface that accepts one or more network interface cards, ports for connection of network devices, Universal Serial Bus (USB) connectors and the like.

As further illustrated in FIG. 1, the financial institution systems 110 comprise computer-readable instructions 118 stored in the memory device 116, which in one embodiment includes the computer-readable instructions 118 of a benefactor application 117, online banking applications 152, beneficiary applications 154, or other applications. In some embodiments, the one or more memory devices 116 include one or more datastores 119 for storing data related to the financial institution systems 110, including, but not limited to, data created and/or used by the benefactor application 117, online banking applications 152, beneficiary applications 154, or other applications.

The benefactor application 117 may be a tool, website, mobile device app, other computer system app, or the like that is used to allow the user to view, receive, or input information for creating and updating a benefactor profile for a benefactor. For example, as discussed in further detail later the benefactor application 117 may allow the first users 104 to create designations for a beneficiary to receive an asset from one or more financial accounts managed by the benefactor. This may include uploading a testamentary document that includes such a designation and allowing the financial institution system 110 to review the testamentary document to identify such designations. The beneficiary applications 154 may allow the other users 106, or representatives of the financial institution, to view information about designations made by the benefactor that include the beneficiary.

As illustrated in FIG. 1, users 104, 106 may access the benefactor application 117 and the beneficiary applications 154 or other financial institution applications, through a user computer system 120. The user computer system 120 may be a desktop, laptop, tablet, mobile device (e.g., smartphone device, or other mobile device), or any other type of computer that generally comprise one or more communication devices 122, one or more processing devices 124, and one or more memory devices 126.

The one or more processing devices 124 are operatively coupled to the one or more communication devices 122, and the one or more memory devices 126. The one or more processing devices 124 use the one or more communication devices 122 to communicate with the network 102 and other devices on the network 102, such as, but not limited to, the financial institution systems 110, the third-party systems 140, and/or other systems not specifically illustrated. As such, the one or more communication devices 122 generally comprise a wireless transceiver, modem, server, electrical connection, or other device for communicating with other devices on the network 102. The one or more communication devices 112 may further include an interface that accepts one or more network interface cards, ports for connection of network devices, Universal Serial Bus (USB) connectors and the like. Moreover, the one or more communication devices 112 may include a keypad, keyboard, touch-screen, touchpad, microphone, mouse, joystick, other pointer device, button, soft key, and/or other input device(s) for communicating with the users 104, 106.

As illustrated in FIG. 1, the user computer systems 120 may have computer-readable instructions 128 stored in the one or more memory devices 126, which in one embodiment includes the computer-readable instructions 128 of a web browser application or another dedicated application 127 that allows the users 104, 106 to access the benefactor application 17, the beneficiary application 154 or other financial institution applications, or receive or update a benefactor profile within the benefactor application 117, or other financial institution applications, or access or received information from other applications, or third-party systems 140 (e.g., applications from other financial institutions, or the like). In some embodiments, the one or more memory devices 126 include one or more datastores 129 for storing data related to the client computer systems 120, including but not limited to data created and/or used by the web browser/application 127. The web browser/application 127 may be utilized by the user 104 to access the benefactor application 117, or other financial institution applications, or receive information from and make updates to the benefactor application 117, or other financial institution applications, to view and/or access a financial planning information (e.g., suggestions to take with respect to financial accounts or other assets or liabilities, or the like). The web browser may be an application that allows the users 104, 106 to access websites over a distributed network of systems (e.g., servers), such as the Internet or an intranet. The application may be a dedicated application for a computer or mobile device that allows the users 104, 106 to access information over the distributed network of systems (e.g., servers), such as the Internet or an intranet.

The third-party systems 140 (e.g., other financial institution systems, merchant systems, other entity systems) are operatively coupled to the financial institution systems 110, and user computer systems 120, through the network 102. The third-party systems 140 have devices the same as or similar to the devices described for the financial institution systems 110 and the user computer systems 120 (e.g., one or more communication devices, one or more processing devices, one or more memory devices with computer-readable instructions, one or more datastores, or the like). Thus, the third-party systems 140 communicate with the financial institution systems 110, the user computer systems 120, and/or each other in the same or similar way as previously described with respect to the financial institution systems 110, and the user computer systems 120. The third-party systems 140, in some embodiments, provide additional information about the users 104, 106 such as but not limited to user profile information, the user's assets and liabilities, the user's investments, the user's transactions, or the like that stored by other financial institutions, merchants, or entities, which may be used by the benefactor application 117, or the like.

In some embodiments of the invention one or more of the systems may be combined with each other, or otherwise perform the functions of the other systems described herein. In other embodiments of the invention, one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems described herein. For example, a portion of the benefactor 117 may be stored on the user computer systems 120, or may be included as a portion of the online banking applications 152, in order to achieve the invention described herein.

It should be understood, that the systems described in FIG. 1 may be configured to establish a communication link with each other in order to accomplish the steps of the processes described herein. The link may be an internal link within the same entity (e.g., within the same financial institution) or a link with the other entity systems described herein (e.g., social networking systems, third-party systems, or the like). In some embodiments, the systems may be configured for selectively monitoring accounts of multiple users on different systems. These feeds of account data can be provided via wireless network path portions through the Internet. When the system is not monitoring a source, the data need not be transmitted from the source to the Internet, although it could be. The sources of data may be made continuously available, however, continuously available does not necessarily mean that the sources actually continuously generate data, but that a source is continuously available to generate and send data real-time (i.e., within a few seconds, or the like) of receiving a request for it. In any case, the sources are continuously available to generate data, in some cases in digitized data in Internet Protocol (IP) packet format. In response to continuously monitoring the real-time data feeds from the various systems, the system may be configured to update the account information associated with the finances of multiple users, as described herein.

Moreover, it should be understood that the process flows described herein include transforming the retrieved data from the different systems (e.g., internally or externally) from the data format of the various systems to a data format associated with the benefactor application 117 for display. Data is converted within the computer environment in many ways. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is capable of storing the output data in a number of different formats. Such a program may be used to convert a file format. If the source format or target format is not recognized, then at times a third program may be available which permits the conversion to an intermediate format, which can then be reformatted.

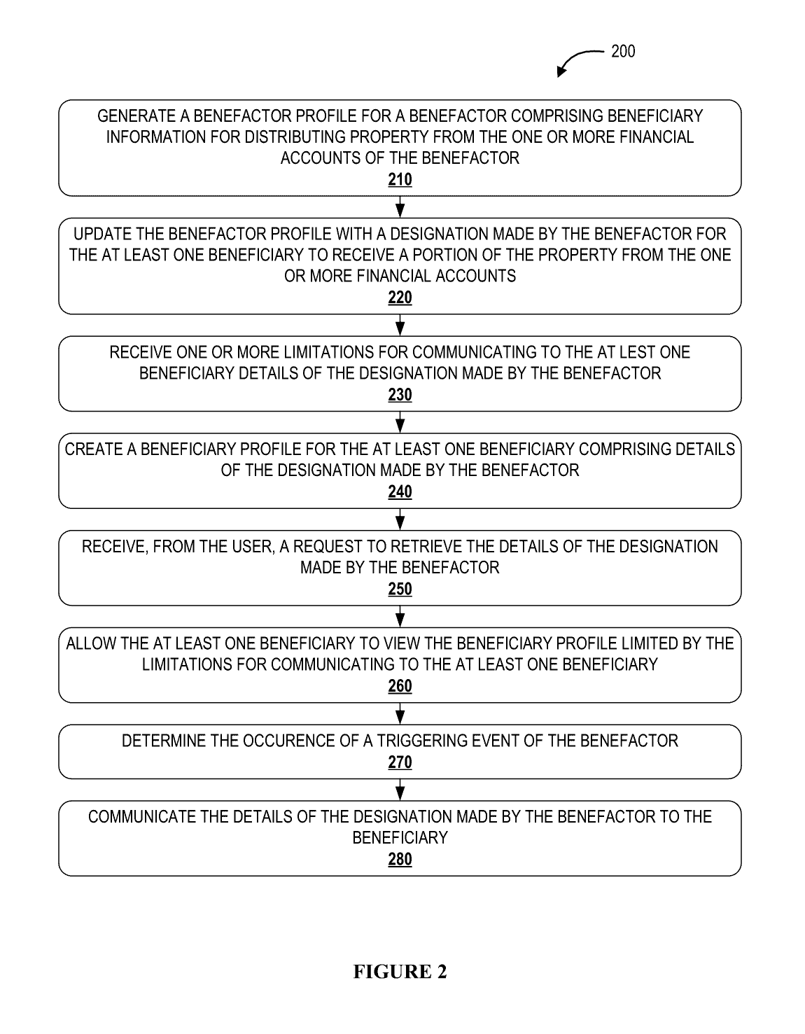

FIG. 2 illustrates a high-level process flow 200 for communicating beneficiary information, in accordance with several embodiments of the present invention. In block 210, in some embodiments, a benefactor profile is generated for a benefactor. The benefactor profile comprises beneficiary information for distributing assets from one or more financial accounts managed by the benefactor. The benefactor profile may further include account identifiers, manager information for each of the accounts, account types, limitations for performing transactions on the account, limitations on transferring assets within the account, and the like. The information may also include asset information relating to assets included in each of the accounts (e.g. an amount of funds of the account). The benefactor profile may be updated to include designations made by the benefactor for beneficiaries to receive assets from the one or more accounts. These designations will be described more fully in block 220.

As illustrated by block 220 in FIG. 2 the benefactor profile is updated with a designation made by the benefactor for the at least one beneficiary to receive a portion of the asset from the one or more financial accounts managed by the benefactor. As described herein, the benefactor profile contains information related to the financial accounts managed by the benefactor. The benefactor profile may further be updated to include beneficiary information that directs the assets of the financial accounts to be distributed to one or more beneficiaries upon the happening of a triggering event defined by the benefactor. In some instances, the triggering event may be the death of the benefactor.

In some embodiments, the benefactor profile may be updated based on a testamentary document of the benefactor (e.g. will). The testamentary document will include designations made by the benefactor to distribute assets to at least one beneficiary. The designations made by the benefactor are identified within the testamentary document. The designations are used to update the profile. For example, a benefactor may have a will that designates assets from Account A to be distributed to Beneficiary. Based on this designation, an identification may be made for the account that includes the asset, an amount and type of the asset of the account, and the beneficiary of the designation.

In another embodiment, the benefactor profile may be communicated to the benefactor. After the benefactor has received the benefactor profile, the benefactor may be allowed to update the benefactor profile with designations as described above. For example, a graphical user interface may be generated that is communicated to the benefactor. The graphical user interface would include features that allow the benefactor to make determinations for distributing assets of the financial accounts to at least one beneficiary. The graphical user interface may further comprise code that enables a machine upon which the graphical user interface is displayed to communicate the designations made by the benefactor to a system that will use the designations to update the benefactor profile.

The details of the designation made by the benefactor may comprise at least a type of the one or more financial accounts, information related to additional beneficiaries of the one or more financial accounts, an executor of the account, and an identifier of the benefactor.

In other embodiments of the invention, the benefactor may further designate one or more contingent beneficiaries to receive assets in place of the initial beneficiary if the initial beneficiary is ineligible to receive assets. Upon the occurrence of the triggering event, eligibility of the initial beneficiary to receive the assets is determined. If the initial beneficiary is ineligible to receive the assets, the contingent beneficiary may receive the assets. Alternatively, the beneficiary may designate one or more contingent beneficiaries if the beneficiary is found to be ineligible to receive the assets. The beneficiary predeceasing the benefactor may be a reason for the beneficiary to be ineligible to receive the assets.

In block 230, one or more limitations are received that direct a system to limit communications to a beneficiary concerning details of the designation made by the benefactor. A benefactor may wish to limit to whom information about the designations be sent and at what times such individuals receive the communications. The limitations described herein may limit to whom communications are sent and when the communications may be sent. In some embodiments, the limitation may be for a period of time (e.g. five years) or may be a specific date. In other embodiments, the limitation may be related to a person (e.g. the beneficiary). In a specific example, the benefactor may set a limitation for communicating details of the designation such that a beneficiary may not receive details of the designation until after the designation becomes effective. In some embodiments, the benefactor may specify which details may be communicated to the beneficiary. For example, the benefactor may elect to withhold an amount of the asset of an account to which the beneficiary may be entitled.

Block 240 illustrates a beneficiary profile for that at least one beneficiary being created. The beneficiary profile comprises details of the designation made by the benefactor. Using the benefactor profile, a profile for each of the beneficiaries is created. One or more benefactor profiles are reviewed to create the beneficiary profile. The beneficiary profile includes information about each designation made by a benefactor where the beneficiary of the beneficiary profile will receive assets from one or more financial accounts. Because the beneficiary profile is based on the benefactor profile, the benefactor profiles may be reviewed to determine if an update has been made to each of the benefactor profiles that would influence the beneficiary profile. If a change in the benefactor profile is detected, the beneficiary profile may be updated accordingly.

In block 250, a request to retrieve details of the designation made by the benefactor is received from the beneficiary or a representative of the beneficiary. In some embodiments, a graphical user interface may be generated and communicated to a beneficiary. The beneficiary may be allowed to enter information into the graphical user interface that would identify the beneficiary. This information may include a name, birthdate, a government-issued identification, and the like. In other embodiments, the benefactor may be allowed to enter benefactor information to identify a particular benefactor and possibly any designations made by the benefactor that name the beneficiary. The graphical user interface is typically an application that includes code that causes one or more processors on a computing device to present the graphical user interface and enable the user to enter in such information. The graphical user interface may include additional information that causes the one or more processors of the computing device to communicate the information to a system to process the information. The information entered by the beneficiary and communicated by the computing device that displays the graphical user interface is received, and an attempt to identify the beneficiary based on the information is performed. If a match is found, a determination of whether a beneficiary profile for the beneficiary has been created is performed. In the event a beneficiary profile has not been created, a new beneficiary profile for the beneficiary is created as described in block 240.

Block 260 illustrates the at least one beneficiary being allowed to view the beneficiary profile limited by the limitations for communicating to the at least one beneficiary. After the beneficiary has been identified and a beneficiary profile has been created for the beneficiary, details of a designation made by a benefactor for the beneficiary to receive assets from one or more accounts may be communicated. A further determination as to whether any of the designations that name the beneficiary includes a limitation is made. If the designation includes a limitation, the details of the designation will be communicated based on these limitations. Therefore, if the designation includes a limitation such that a beneficiary may not receive details of the designation until after the designation becomes effective, the details of the designation will not be communicated until after the designation becomes effective. In other embodiments, a notification that the beneficiary is an actual beneficiary may still be communicated. For example, a notification that the user is beneficiary to three designations may be communicated without providing further details of each of the designation.

In block 270, a determination is made as to whether an occurrence of a triggering event of the benefactor has occurred. In some embodiments, the triggering event may occur based on the fulfillment of a life event of the benefactor. This may include a wedding, a birth of a child, school or college, the purchase of a new home, retirement, and the like. In other embodiments, the triggering factor may be determined based on the death of the benefactor. Further, the limitations discussed in block 230 may expire upon the occurrence of the triggering event such that details of the designation may be communicated without restriction. In other embodiments, the benefactor may designate which limitations may expire upon the occurrence of the triggering event. For example, the benefactor may provide a first limit that prevents communication of the details of a designation to a beneficiary until the death of the benefactor. Upon the death of the benefactor, the limitation expires, and the beneficiary may receive details of the designation. The benefactor may also include a second limitation to prevent any communication of a designation to other individuals other than the beneficiary even after the death of the benefactor. Therefore, upon the death of the benefactor, only the beneficiary may receive the details and the second limitation will remain in effect.

As illustrated in block 270, a communication of the details of the designation may be sent to the beneficiary after the occurrence of the triggering event of the benefactor. In some embodiments, the beneficiary may view the details of the designation via a graphical user interface generated by the invention. In addition to displaying the details, the graphical user interface may further present options for the user. One option may be for the beneficiary to receive updates or alerts regarding changes to the beneficiary profile of the beneficiary. The changes may be as a result of the changes made by a benefactor in the benefactor profile. Further, the beneficiary may specify a time period for receiving updates. For example, the beneficiary may elect to receive alerts from the system every time there is a change to the beneficiary profile and every 30 days. Other information in an alert may include changes to an account of the benefactor that includes property associated with the beneficiary. Additionally, the alert may include information about changes to other accounts of the benefactor.

In addition to notifying the beneficiary of the triggering event, additional notifications may be sent to other individuals. These individuals may include an executor, an individual holding a power-of-attorney, a caretaker, and other individuals that are associated with an account of the benefactor. Where an individual has control over an account prior to the occurrence of the triggering event, the benefactor may specify that such control should end upon the occurrence of the triggering event. For example, a person may hold a power-of-attorney for the benefactor that enables the person to manage an account of the benefactor. The benefactor may update the benefactor profile to specify that such control should cease upon the occurrence of the triggering event. Upon detection of the triggering event, the control of the individual may be terminated and a notification communicated to the individual describing the occurrence of the triggering event and the termination of the control over the account. Alternatively, an individual (e.g. executor) may gain control over one or more accounts based on the occurrence of the triggering event. Based on an update to the benefactor profile, control may be granted to an executor of one or more accounts and a notification communicated to the benefactor detailing the change.

In some embodiments, one or more updates may be received the changes the designations made by the benefactor for the beneficiary to receive the assets from the one or more financial accounts managed by the benefactor. An update to the beneficiary profile may be made and a notification communicated to the beneficiary based on the limitations prescribed by the benefactor.

When the determination has been made that the asset is authorized for distribution, a level of authorization may be made that allows the beneficiary to manage the asset of the one or more financial accounts managed by the benefactor.

In other embodiments, instead of updating the level of authorization for the beneficiary, an account may be identified for the beneficiary to receive the asset from the one or more accounts. After identifying an account of the beneficiary, the asset may be transferred from the one or more accounts into the identified account of the beneficiary. In such an instance, not all of the assets of the account may have been distributed. In such a case, the individual may be notified that asset remains in one of the one or more financial accounts managed by the benefactor. This person may be a beneficiary or an executor of the account.

In other embodiments, the at least one beneficiary may be notified of additional financial accounts managed by the benefactor.

Typically, change in management of an account and/or distribution on assets or property within an account may not be performed until after authorization is granted from a court or other judiciary body. Such authorization may be as a result of a probate or testamentary proceeding. In other embodiments, the proceedings may determine the competency of the benefactor in self-managing affairs. The present invention may employ a system to receive documentation and or other evidence from such proceedings. Using this documentation, the appropriate changes may be made in the management of the account and/or the distribution of the various assets.

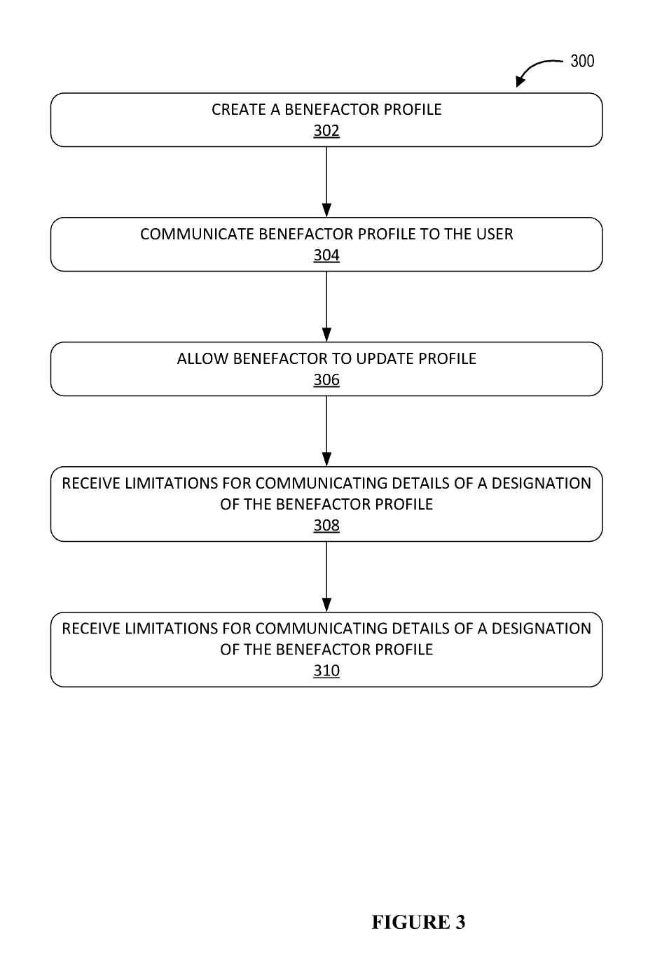

FIG. 3 presents a process flow 300 for creating and updating a benefactor profile, in accordance with various embodiment of the present invention. Block 310 illustrates creating a benefactor profile. A system that is configured to perform one or more of the steps of the process flow 300 may be configured to generate a benefactor profile for a benefactor that manages one or more financial accounts. The benefactor profile may include beneficiary information for distributing assets from one or more financial accounts of the benefactor. This information may include account identifiers, managers for each of the accounts, account types, executors of an estate of the benefactor, limitations for performing transactions on the account, limitations on transferring assets within the account, and the like. The information may further include asset information relating to assets included in the accounts. The benefactor profile may be updated to include designations made by the benefactor for beneficiaries to receive assets from the one or more accounts.

Block 304 illustrates communicating the benefactor profile to the benefactor and allowing the benefactor to update the benefactor profile, as illustrated in block 306. The benefactor may be allowed to enter in designations for one or more beneficiaries to receive assets from a financial account managed by the benefactor. The benefactor profile may further be updated to include beneficiary information that directs the assets of the financial accounts to be distributed to one or more beneficiaries upon the happening of a triggering event defined by the benefactor. As described herein, the triggering event may be determined based on the death of the benefactor.

In some embodiments, the benefactor profile may be updated based on a testamentary document of the benefactor (e.g. will). The testamentary document will include designations made by the benefactor to distribute assets to at least one beneficiary. The system may be configured to identify the designations made by the benefactor within the testamentary document and update the profile based on these designations. The testamentary document may be received based on a manual entry or based on the document being scanned. Wherein the testamentary document is scanned, the text of the scanned document is converted (e.g. OCR) to a medium that is readable by a computing device. The designations included in the testamentary document may be compared to actual assets or accounts owned or managed by the benefactor. Discrepancies may be identified and communicated. For example, a will of the benefactor may include a designation for a beneficiary to receive assets from Account A. Upon review of the accounts of the benefactor, it is determined that Account A does not exist. A notification may be sent to at least the benefactor to inform the benefactor of the discrepancy. Additionally, a discrepancy may be determined if the account has insufficient assets to cover the designation made by the benefactor.

In yet other embodiments, the benefactor may be enabled to update the benefactor profile to include functions that are performed after the occurrence of the triggering events. The functions may be performed by a system of the invention that is configured to perform such functions. The functions may include financial transactions that the benefactor would like to perform after the triggering event. For example, a function may include setting up an account, transferring money into the account, and establishing a manager over the account. In other embodiments, the function may be to communicate documents to an insurance company that manages a policy of the benefactor. Additionally, the function could be to list a particular asset for sale. In some embodiments, after the occurrence of the triggering event, the system may automatically perform each of the functions defined by the benefactor. In other embodiments, the benefactor may designate an individual to oversee the completion of the function (e.g. executor). The system may generate a graphical user interface that displays information regarding the function and presents an option for the individual to complete the transaction. The system may be enabled to receive a response that the individual would like to complete the function. The system may then be configured to complete the function. Following the above example, after the triggering event, the system may present a graphical user interface to an executor of the estate of the benefactor. The graphical user interface illustrates the function of creating the account, transferring funds into the account, and establishing a manager over the account. The graphical user interface further displays a button that enables the executor to perform the function. Upon the executor selecting the button, the system may then automatically perform the functions. Thus, the executor decides that the function should be performed whiled the system actually performs the function. In other embodiments, the function may leave certain fields that need to be defined by the individual. This might include information that may not be available to the benefactor when defining the function. Following the above example, the function may allow the executor to define the manager of the account or an amount of funds to transfer. In some embodiments, the field may be selectable by the benefactor. For example, the benefactor may define a primary manager of the account and a secondary manager that would manage the account if the primary manager was unavailable. The graphical user interface would then present an option for the executor to select either the primary manager or the secondary manager based on information that is discovered by the executor after the triggering event. By allowing a benefactor to define these functions, an executor or another individual may efficiently perform the duties of the appointed position while maintaining control over the process. Thus, the benefactor may define with detail how to dispose of given assets.

In other embodiments of the invention, the benefactor may update the benefactor profile to provide incentives to one or more of the beneficiaries named in the benefactor profile. These incentives may be conditions of the designation established by the benefactor. For example, the benefactor could define an incentive of “Beneficiary A to receive Asset X if Beneficiary A has graduated college upon the occurrence of the triggering event.” A determination of whether Beneficiary A has gradated college is performed and if so, the designation is fulfilled. Alternatively, if the condition has not been performed, the designation is not fulfilled. In other embodiments, the incentive may be an enticement for the beneficiary to perform an action to receive an additional benefit to the designation. For example, the designation may state, “Beneficiary A to receive 10% of the asset in Account A, and if the Beneficiary should graduate college, an additional 5% of the asset in Account A.” In another embodiment, the beneficiary may be given the option to complete multiple incentives. For example, the designation may state concerning the distribution of assets of an account to a beneficiary, “1% for each year complete of education, 5% if married, 2% for each child, etc.” Thus, the beneficiary is incentivized to perform multiple actions. After the occurrence of the triggering event, an identification may be made to determine which of the incentives the beneficiary has completed. Based on the incentives the beneficiary has completed, a calculation is performed to determine that amount the beneficiary may receive under the designation.

As illustrated in block 308, the system may receive limitations for communicating details of a designation within the benefactor profile. The details of the designation made by the benefactor may comprise at least a type of the one or more financial accounts, information related to additional beneficiaries of the one or more financial accounts, an executor of the account, and an identifier of the benefactor. A benefactor may wish to limit to whom information about the designations be sent and at what times such individuals receive the communications. The limitations described herein may limit to whom communications are sent and when the communications may be sent.

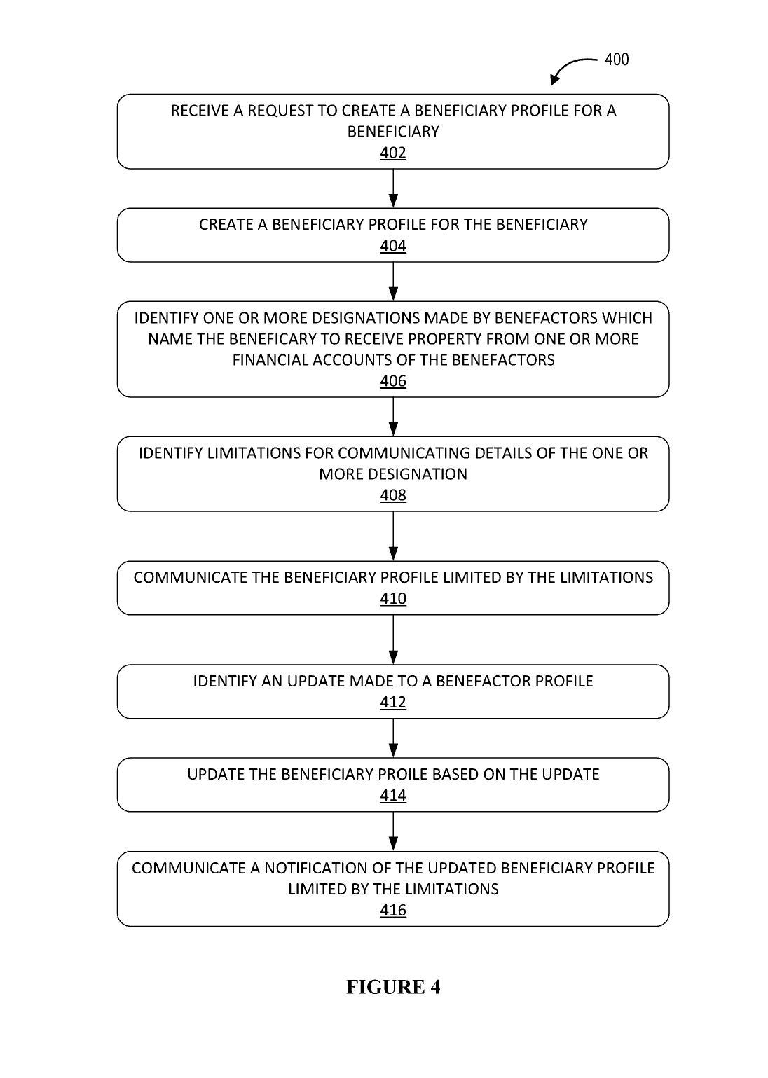

FIG. 4 illustrates a process flow 400 for generating and presenting a beneficiary profile to a beneficiary, in accordance with several embodiments of the present invention. Block 402 illustrates receiving a request to create a beneficiary profile for a beneficiary. A system that is configured to perform the steps of the process flow 400 may be further configured to generate a graphical user interface to display on a computer device of the requestor. The graphical user interface may include features that allow the benefactor to submit information about the beneficiary. This information may include, but is not limited to, a name, an address, a government-issued identifier, a birthdate, and the like. In some embodiments, the graphical user interface may also allow the benefactor to enter information related to a particular benefactor. Further, the graphical user interface may further instruct the computing device of the requestor to the entered information to the system.

Based on the system receiving the entered information, the system may first determine whether a beneficiary profile has been created for the beneficiary and if not generate a beneficiary profile, as illustrated in block 404. The beneficiary profile will include information related to designations made by benefactors that name the beneficiary to receive assets from one or more financial accounts that are identified in block 406. The system may review benefactor profiles, described in FIG. 3, to identify such designations. After reviewing the benefactor profiles and discovering the designations, the system may update the beneficiary profile accordingly.

In some embodiments, the designations included in the benefactor profiles may include limitations for communicating details of the designations, as defined in block 408. The limitations described herein may limit to whom communications are sent and when the communications may be sent. One or more of the limitations may expire upon the occurrence of a triggering event of the benefactor. As described herein, the triggering event may include the death of the benefactor. Alternatively, in some embodiments, the limitation may be for a period of time (e.g. five years) or may be based on the happening of a specific date.

In addition to limiting when the communications may or may not be sent, the limit may further define a person or group of people to whom the limit applies. In a specific example, the benefactor may set a limitation such that a beneficiary may not receive details of the designation until after the death of the benefactor. Further, in some embodiments, the benefactor may specify which details may be communicated to the beneficiary. For example, the benefactor may elect to withhold details related to an amount of the assets of an account to which the beneficiary may be entitled. Based on these limitations, the beneficiary profile is communicated as illustrated in block 410.

Block 412 illustrates identifying an update made to a benefactor profile. This identification may be made as a result of the system reviewing the benefactor profile. The change to the benefactor profile may include a change to a limitation or a change to a designation for the beneficiary to receive assets from one or more financial accounts managed by the benefactor. When the system makes this identification, the system may be configured to update the beneficiary profile based on the update, as illustrated in block 414. This notification may be further communicated as a result of the beneficiary selecting to receive such notifications.

After updating the beneficiary profile, the system may be configured to communicate a notification of the updated beneficiary profile subject to the limitations described herein, as illustrated in block 416.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 6810US1.014033.2511 | 14/851,750 | SYSTEM FOR RESTRUCTURING | Sep. 11, 2015 |
| | | BASED ON PREDICTIVE ANALYSIS | |
| 6811US1.014033.2512 | 14/851,758 | UNIVERSAL TOKENIZATION | Sep. 11, 2015 |
| | | SYSTEM | |
| 6812US1.014033.2513 | 14/851,599 | SYSTEM FOR MODELING AND | Sep. 11, 2015 |
| | | IMPLEMENTING EVENT- | |
| | | RESPONSIVE RESOURCE | |
| | | ALLOCATION STRUCTURES | |
| 6813US1.014033.2514 | 14/851,623 | SYSTEM FOR SIMULATION AND | Sep. 11, 2015 |
| | | IMPLEMENTATION OF DYNAMIC | |
| | | STATE-DEPENDENT RESOURCE | |
| | | RECONFIGURATION | |
| 6815US1.014033.2515 | 14/851,848 | SYSTEM FOR DYNAMIC | Sep. 11, 2015 |
| | | VISUALIZATION OF | |
| | | INDIVIDUALIZED CONSUMPTION | |
| | | ACROSS SHARED RESOURCE | |
| | | ALLOCATION STRUCTURE | |
| 6817US1.014033.2516 | 14/851,765 | SYSTEM FOR ANALYZING PRE- | Sep. 11, 2015 |
| | | EVENT AND POST-EVENT | |
| | | INDIVIDUAL ACCOUNTS AND | |
| | | TRANSFORMING THE ACCOUNTS | |
| 6818US1.014033.2517 | 14/851,769 | SYSTEM FOR OPENING AND | Sep. 11, 2015 |
| | | CONSOLIDATING ACCOUNTS | |
| | | BASED ON AN EVENT | |
| | | ASSOCIATED WITH THE ACCOUNT | |
| | | HOLDER | |
| 6824US1.014033.2518 | TBD | SYSTEM FOR DETERMINATION | Concurrently |
| | | AND TRACKING OF ASSET | Herewith |
| | | LINEAGE | |
| 6825US1.014033.2519 | TBD | SYSTEM FOR DETERMINATION | Concurrently |
| | | AND TRANSFER OF ASSETS | Herewith |
| 6826US1.014033.2520 | TBD | SYSTEM FOR RESTRUCTURING | Concurrently |
| | | BASED ON INTENT ANALYSIS | Herewith |
| 6827US1.014033.2521 | TBD | SYSTEM FOR ASSESSMENT OF | Concurrently |
| | | ALLOCATED ASSETS | Herewith |
| 6828US1.014033.2522 | TBD | SYSTEM FOR DYNAMIC | Concurrently |
| | | GENERATION OF ALLOCATION | Herewith |
| | | GUIDE FOR ASSETS | |

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. In addition, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions that execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for communicating beneficiary information to a user associated with one or more assets, wherein the system comprises:
a memory;
a communication interface;
one or more processors; and
executable code stored in memory, wherein the code, when executed by the one or more processors, causes the one or more processors to:
store an electronic asset profile for the one or more assets, where the asset profile comprises beneficiary information designating one or more beneficiaries associated with the one or more assets and rules associated with allocation of the one or more assets to the one or more beneficiaries;
store one or more limitations received from a benefactor associated with the one or more assets, where the one or more limitations comprise rules for communicating to a beneficiary regarding details associated with the one or more assets;
create a beneficiary profile for the user, wherein the beneficiary profile includes details associated with the one or more assets that list the user as a beneficiary;
receive from the user a request to retrieve the details associated with the one or more assets from the beneficiary profile; and
allow the user to view the beneficiary profile, where information provided to the user in the displayed beneficiary profile is limited by the one or more limitations for communicating details included in the beneficiary profile, whereby the user only sees information regarding the one or more assets as instructed by the benefactor associated with the one or more assets.

2. The system of claim 1, wherein the executable code further comprises instruction code configured to cause the one or more processors to:
receive electronic information from a testamentary document of a benefactor;
identify, from the testamentary document, a testamentary designation made by the benefactor regarding an asset including one or more designations of beneficiaries; and
update the asset profile for the one or more beneficiaries associated with the asset based on the testamentary designation.

3. The system of claim 1, wherein the executable code further comprises instruction code configured to cause the one or more processors to:
generate a benefactor profile for the benefactor, wherein the benefactor profile includes a list of assets owned or controlled by the benefactor and designates beneficiary information for each asset;
receive one or more updates to the list of assets owned or controlled by the benefactor, wherein the one or more updates comprise at least one of a change to an amount or type of an asset of the list of assets, and a change to a beneficiary associated with at least one asset of the list of assets;
update the asset profile and the beneficiary profile based on the one or more updates; and
communicate a notification to the beneficiary associated with the at least one asset, wherein the notification is based on the one or more updates, wherein the communication is limited by the one or more limitations for communicating details included in the beneficiary profile.

4. The system of claim 1, wherein the beneficiary information comprises at least a type of one or more financial accounts associated with the asset profile, information related to additional beneficiaries of the one or more financial accounts, an executor of the one or more financial accounts, and an identifier of the benefactor.

5. The system of claim 1, wherein the executable code further comprises instruction code configured to cause the one or more processors to:
determine an occurrence of a triggering event associated with an asset;
determine that at least one of the one or more limitations is expired based on the occurrence of the triggering event;
identify one or more details associated with the one or more assets that were not previously communicated to the user due to the one or more limitations; and
communicate the one or more details that were not previously communicated to the user based on determining the occurrence of the triggering event.

6. The system of claim 1, wherein the executable code further comprises instruction code configured to cause the one or more processors to:
determine an occurrence of a triggering event associated with an asset, wherein the triggering event indicates that the asset is available to be distributed;
identify an account of the user for receiving at least a portion of the one or more assets; and
transfer at least the portion of the one or more assets into the identified account of the user.

7. A computer program product for communicating beneficiary information to a user associated with one or more assets, the computer program product comprising:
a computer readable storage medium having computer readable program code embodied therewith, the computer readable program code being configured to cause one or more processors to:
store an electronic asset profile for the one or more assets, where the asset profile comprises beneficiary information designating one or more beneficiaries associated with the one or more assets and rules associated with allocation of the one or more assets to the one or more beneficiaries;
store one or more limitations received from a benefactor associated with the one or more assets, where the one or more limitations comprise rules for communicating to a beneficiary regarding details associated with the one or more assets;
create a beneficiary profile for the user, wherein the beneficiary profile includes details associated with the one or more assets that list the user as a beneficiary;
receive from the user a request to retrieve the details associated with the one or more assets from the beneficiary profile; and
allow the user to view the beneficiary profile, where information provided to the user in the displayed beneficiary profile is limited by the one or more limitations for communicating details included in the beneficiary profile, whereby the user only sees information regarding the one or more assets as instructed by the benefactor associated with the one or more assets.

8. The computer program product of claim 7, wherein updating the benefactor profile comprises:
receive electronic information from a testamentary document of a benefactor;
identify, from the testamentary document, a testamentary designation made by the benefactor regarding an asset including one or more designations of beneficiaries; and
update the benefactor profile for the one or more beneficiaries associated with the asset based on the testamentary designation.

9. The computer program product of claim 7, wherein the computer readable program code being further configured to cause the one or more processors to:
generate a benefactor profile for the benefactor, wherein the benefactor profile includes a list of assets owned or controlled by the benefactor and designates beneficiary information for each asset;
receive one or more updates to the list of assets owned or controlled by the benefactor, wherein the one or more updates comprise at least one of a change to an amount or type of an asset of the list of assets, and a change to a beneficiary associated with at least one asset of the list of assets;
update the asset profile and the beneficiary profile based on the one or more updates; and
communicate a notification to the beneficiary associated with the at least one asset, wherein the notification is based on the one or more updates, wherein the communication is limited by the one or more limitations for communicating details included in the beneficiary profile.

10. The computer program product of claim 7, wherein the beneficiary information comprises at least a type of one or more financial accounts associated with the asset profile, information related to additional beneficiaries of the one or more financial accounts, an executor of the one or more financial accounts, and an identifier of the benefactor.

11. The computer program product of claim 7, wherein the computer readable program code being further configured to cause the one or more processors to:
determine an occurrence of a triggering event associated with an asset;
determine that at least one of the one or more limitations is expired based on the occurrence of the triggering event;
identify one or more details associated with the one or more assets that were not previously communicated to the user due to the one or more limitations; and
communicate the one or more details that were not previously communicated to the user based on determining the occurrence of the triggering event.

12. The computer program product of claim 7, wherein the computer readable program code being further configured to cause the one or more processors to:
determine an occurrence of a triggering event associated with an asset, wherein the triggering event indicates that the asset is available to be distributed;
identify an account of the user for receiving at least a portion of the asset; and
transfer at least the portion of the asset into an account of the user.

13. A computer-implemented method for communicating beneficiary information to a user associated with one or more assets, the method comprising:
storing an electronic asset profile for the one or more assets, where the asset profile comprises beneficiary information designating one or more beneficiaries associated with the one or more assets and rules associated with allocation of the one or more assets to the one or more beneficiaries;
storing one or more limitations received from a benefactor associated with the one or more assets, where the one or more limitations comprise rules for communicating to a beneficiary regarding details associated with the one or more assets;
creating a beneficiary profile for the user, wherein the beneficiary profile includes details associated with the one or more assets that list the user as a beneficiary;
receiving from the user a request to retrieve the details associated with the one or more assets from the beneficiary profile; and
allowing the user to view the beneficiary profile, where information provided to the user in the displayed beneficiary profile is limited by the one or more limitations for communicating details included in the beneficiary profile, whereby the user only sees information regarding the one or more assets as instructed by the benefactor associated with the one or more assets.

14. The computer implemented method of claim 13, the method further comprises:
receiving electronic information from a testamentary document of a benefactor;
identifying, from the testamentary document, a testamentary designation made by the benefactor regarding an asset including one or more designations of beneficiaries; and
updating the benefactor profile for the one or more beneficiaries associated with the asset based on the testamentary designation.

15. The computer implemented method of claim 13, wherein the method further comprises:
generating a benefactor profile for the benefactor, wherein the benefactor profile includes a list of assets owned or controlled by the benefactor and designates beneficiary information for each asset;
receiving one or more updates to the list of assets owned or controlled by the benefactor, wherein the one or more updates comprise at least one of a change to an amount or type of an asset of the list of assets, and a change to a beneficiary associated with at least one asset of the list of assets;
updating the asset profile and the beneficiary profile based on the one or more updates; and
communicating a notification to the beneficiary associated with the at least one asset, wherein the notification is based on the one or more updates, wherein the communication is limited by the one or more limitations for communicating details included in the beneficiary profile.

16. The computer implemented method of claim 13, wherein the beneficiary information comprises at least a type of one or more financial accounts associated with the asset profile, information related to additional beneficiaries of the one or more financial accounts, an executor of the one or more financial accounts, and an identifier of the benefactor.

17. The computer implemented method of claim 13, wherein the method further comprises:
determining an occurrence of a triggering event associated with an asset;
determining that at least one of the one or more limitations is expired based on the occurrence of the triggering event;
identifying one or more details associated with the one or more assets that were not previously communicated to the user due to the one or more limitations; and
communicating the one or more details that were not previously communicated to the user based on determining the occurrence of the triggering event.

18. The computer implemented method of claim 13, wherein the method further comprises:
determining an occurrence of a triggering event associated with an asset, wherein the triggering event indicates that the asset is available to be distributed;
identifying an account of the user for receiving at least a portion of the asset; and
transferring at least the portion of the asset into an account of the user.
